(19) United States
(12) Patent Application Publication
(10) Pub. No.: US 2014/0324556 A1
(43) Pub. Date: Oct. 30, 2014

(54) SYSTEM AND METHOD FOR EXPERTISE PERFORMANCE MANAGEMENT

(71) Applicant: The Glassbox Incorporated, Old Brookville, NY (US)

(72) Inventors: Dorothy Young DAVIDOW, Glen Head, NY (US); Richard J. Levinson, Larchmont, NY (US); Paul A. Sciandra, Cumming, GA (US); Ramkaran Rudravaram, Vinay Nagar (IN)

(73) Assignee: The Glassbox Incorporated, Old Brookville, NY (US)

(21) Appl. No.: 14/266,350

(22) Filed: Apr. 30, 2014

Related U.S. Application Data
(60) Provisional application No. 61/817,765, filed on Apr. 30, 2013.

(51) Int. Cl. G06Q 10/06

(52) U.S. Cl. CPC G06Q 10/06398
USPC 705/7.42

(57) ABSTRACT

A method and system is provided for evaluating responders and/or their work. A submission may be received from each of a plurality of responders in response to a request for information. A request may be received to incorporate the submission from at least one of the responders into a project. Upon receiving the request to incorporate the submission, embodiments of the invention may automatically check whether or not the submission has been evaluated and rated by a human reviewer. If the submission has been evaluated and rated by the human reviewer, the submission may be incorporated into the project, whereas if the work has not been evaluated and rated by the human reviewer, the request may be denied and the submission may be prohibited from being incorporated into the project.

### FIELD OF THE INVENTION

Embodiments of the invention relate to a system and method of evaluating work collected from a plurality of users, such as, employees in a company, members on a project team or external responders to a questionnaire.

### BACKGROUND OF THE INVENTION

Employee performance evaluations provide valuable information for managing personnel, such as, a team working on a project or employees in a company. Evaluations enable management to determine, for example, which employees are most valuable to the company for salary, promotion or benefit purposes, and to determine strengths and weaknesses of employees for training purposes or to assign employees to the tasks that are most aligned with their strengths.

In conventional industries, employee evaluations typically occur periodically, e.g. annually, but not necessarily at the time when the employee's work is being used. Thus, evaluations are typically based on the memory or recall of the reviewers, which can be unreliable. Further, in most cases, conventional employee evaluation data is generally non-uniform and often biased. Evaluation data may depend on many subjective factors, such as the personal relationship between the reviewer and employee, a reviewer's tendency to evaluate more or less strictly than other reviewers, unreliable memory of the reviewer, e.g. a tendency to forget older work done or a likelihood to give greater weigh to more recent employee performance or projects with which they were personally involved, etc. Accordingly, the conclusions of employee evaluations are often unreliable, skewed and subjective.

In addition, employee evaluations are typically not prioritized, and reviewers often neglect evaluations in order to complete other more pressing work, leaving some employees or work unevaluated. To solve this problem, some companies motivate reviewers to complete employee evaluations by providing incentives, such as employee benefits or options. However, such motivation tactics are ultimately unreliable.

There is, therefore, a great need for providing consistent and uniform evaluations and for ensuring that all employees and their work are evaluated, without exception.

Accordingly, there is now provided with this invention an improved method for effectively overcoming the aforementioned difficulties and longstanding problems inherent in the art.

### SUMMARY OF THE INVENTION

According to an embodiment of the invention, there is provided a system and method for evaluating responders and/or their work. A submission may be received from each of a plurality of responders in response to a request for information. A request may be received to incorporate the submission from at least one of the responders into a project. Upon receiving the request to incorporate the submission, embodiments of the invention may automatically check whether or not the submission has been evaluated and rated by a human reviewer. If the submission has been evaluated and rated by the human reviewer, the submission may be incorporated into the project, whereas if the work has not been evaluated and rated by the human reviewer, the request may be denied and the submission may be prohibited from being incorporated into the project.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 schematically illustrates an expertise performance management system according to an embodiment of the invention;

FIG. 2 schematically illustrates an expertise performance management workflow executed by the system of FIG. 1 according to an embodiment of the invention;

FIG. 3 shows an example user-interface displaying employee performance rankings according to an embodiment of the invention;

FIG. 4 shows an example project displayed on a user-interface according to an embodiment of the invention;

FIG. 5 shows an example of a user-interface for assigning tasks or work requests to responders according to an embodiment of the invention;

FIG. 6 shows an example of a responder user-interface 600 according to an embodiment of the invention;

FIG. 7 shows an example of a project manager user-interface for receiving and reviewing responder submissions according to an embodiment of the invention;

FIG. 8 shows an example of a project manager user-interface for simultaneously using and evaluating responder submissions according to an embodiment of the invention;

FIG. 9 shows an example of a project manager user-interface for designing and generating a report according to an embodiment of the invention;

FIG. 10 shows an example of a user-interface displaying a report, e.g. to be viewed on an executive computer, according to an embodiment of the invention;

FIG. 11 shows an example user-interface displaying a log-on history report of valid log-ins for a specified time period according to an embodiment of the invention;

FIG. 12 schematically illustrates a workflow for generating requests for information, for receiving responders' submissions in response to those requests, and for evaluating those responder/employee submissions, according to an embodiment of the invention;

FIG. 13 schematically illustrates data structures storing responder evaluations and performance reports in a knowledge management database according to an embodiment of the invention; and

FIG. 14 schematically illustrates a workflow showing the changes in state related to performance evaluation according to an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

In certain embodiments of the invention, a project manager may send a request to one or more of a plurality of employees for action, information or data, or some other form of response or feedback to one or more queries or requests for information that is needed by the project manager for a project. The project manager may intend to incorporate at least one or more of the submissions from the employees, i.e., responders to the request, into a project. Embodiments of the invention may include a process flow gateway to automatically lock the work or submissions of each responder to that request for action, information or data from being used, saved, edited and/or incorporated into a project, until that work and/or the responder that generated that work is evaluated by a human reviewer, e.g., the project manager.

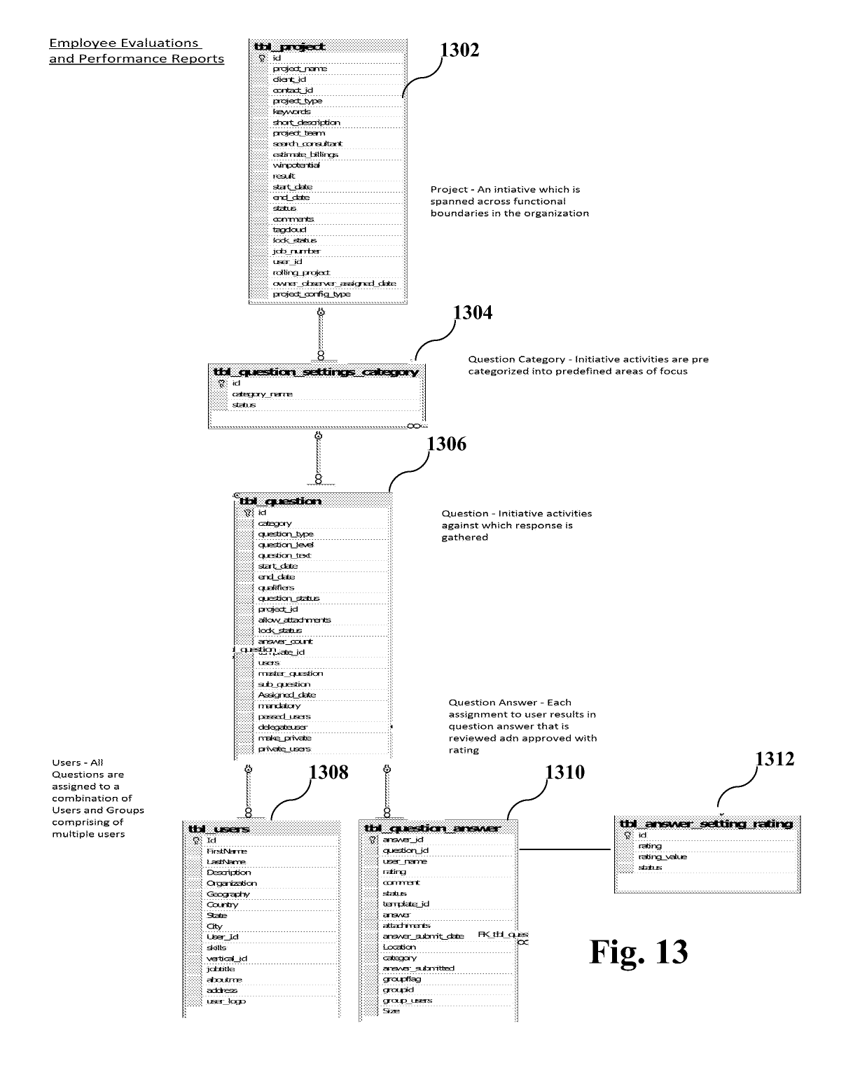

In some embodiments, the evaluation may be generated in the form of data that is incorporated into of the associated work, e.g., as metadata, and may be, for example, stored in a table associated with the work (e.g., table 1312 of FIG. 13, as described below). In order for a responder's work to be used, a processor or module may check if evaluation data (e.g., in the form of metadata) associated with the work has been generated. If sufficient associated evaluation data is detected, then the work is unlocked for use. However, if sufficient associated evaluation data is not detected, then the work is locked and cannot be used until it has been evaluated by the reviewer.

Requiring a reviewer to evaluate the work submission of a responder before that work is unlocked for use by the reviewer or anyone else may ensure that all used work is evaluated. In contrast to typical systems that merely encourage or incentivize submission of evaluations, embodiments of the invention may force evaluations to be completed in order for a project manager to use the work needed for a project. As such, there is no way for the project manager to utilize the work of the responder unless that work is first evaluated. In addition, the evaluation data is clearly captured and displayed for use by the executive or other approved user of the system. The project manager's evaluation and associated work are available for the executive ultimately in charge of the project, ensuring the further accuracy of the work. Further embodiments of the invention may require the reviewer to evaluate work simultaneously to, or during or immediately after a period of considering, reviewing, editing and/or using the work. Evaluating work simultaneously to, during or immediately after using or reviewing the work (e.g., while the quality of that work is fresh in the mind of the reviewer) may significantly improve the quality of the evaluation, e.g., as compared to conventional evaluations that are typically conducted and submitted long after the work was received (e.g., at annual reviews, when many of the details have been forgotten).

Evaluating data may include a plurality of different types: accepting or rejecting work, scoring work or the responders that generate work, e.g., on a scale (1-5 stars, 1-10, or 1-100 such as a percentage), commenting on work or responders, etc. Reviewers may evaluate work actively, e.g., by rating, checking boxes, etc. Alternatively or additionally, reviewers may evaluate work passively, e.g., by simply using the work, such as by incorporating the responder-generated text into a project. Used work may be passively rated as accepted, while unused work may be passively rated as rejected. For active evaluations, a questionnaire may be embedded within the work being evaluated, e.g., in the margins, footer or as a separate adjacent window, to the responder-generated document. In some embodiments, it may be required for such a questionnaire to be completed by the reviewer or project manager before the document can be saved or before any of the work therein can be used, copied or edited.

In one embodiment, in order to allow a responder's work to be used, the processor may check only if evaluation data is entered for that work, while in another embodiment, the processor may check also that each of a plurality of types of evaluation data have been entered, e.g., accepted/rejected evaluation, scoring, commenting, or any combination thereof. These types of evaluation data may be designated, for example, per project, division or company, by an executive or project manager.

Each responder may be linked to an evaluation profile compiled throughout that responder's work history from evaluation data associated with the responder based upon evaluations of work generated by that responder. A project manager may compile a report of the responder's evaluation profile, e.g., for annual reviews, assigning future projects, etc. The evaluation profile data may be filtered by dates, project types, team members, etc.

In one embodiment, a group of responders may act as a single entity that submits work together. In such embodiments, evaluation data for the work generated by the group may be linked to all members of the group evenly, or in some embodiments, unevenly, e.g., weighted according to a group hierarchy or specific input of individuals. In one example, a weighted evaluation may have a higher weight for ranking a group leader than for ranking other members of the group.

Evaluation data may be associated with a responder and/or with the work generated by that responder. In some embodiments, evaluations may operate in two separate modes: responder rating mode (for evaluating only a responder and not the responder's work), or work rating mode (for evaluating only the work submitted so as to select or reuse the best work and not the responder that generated that work), or may operate simultaneously to evaluate both the responder and the work. In the former embodiment, reviewers may toggle or switch between modes. In one example, certain national or professional standards require employee anonymity or prohibit employee evaluations, in which case only work mode may be used.

If multiple reviewers in a company evaluate work, the evaluation data may be inherently skewed, e.g., due to human differences or inherent biases among reviewers. The system clearly shows what work has been evaluated and used vs. rejected. It also keeps the history of edits and comments for future reporting. Deadlines, number of questions and numbers of projects are also captured. In order to make the evaluation data from multiple reviewers more uniform, in some embodiments, the manual data entered by the human reviewers may be automatically normalized, e.g., “curved” so as to correct for or reduce reviewer biases. Normalization factors for each reviewer may be automatically computed during a training period, e.g., based on test questions or a sample work evaluated by each reviewer. Each reviewer's evaluations of the test questions or a sample work may be compared to predetermined or standardized evaluations. Differences from the predetermined evaluations may be computed and used to calculate a weight, equation or normalization factor with which to curve, calibrate or normalize all relevant evaluations generated by that reviewer (such modifications may apply to numerical evaluations such as scoring and rating, but not to comments). In other embodiments, multiple reviewer evaluations for the same or overlapping work may be averaged or combined to reduce individual reviewer bias.

In one embodiment, non-evaluated work may be stored in a separate locked memory structure, from which the non-evaluated work can be moved only after it has been evaluated. Non-evaluated work may have limited permissions, such as, read-only data, to limit its use until the work has been evaluated. In another embodiment, non-evaluated work is automatically discarded after a predetermined lock period. A warning that the work will be deleted unless evaluated, and an anticipated time period for such deletion, may be issued to the reviewer.

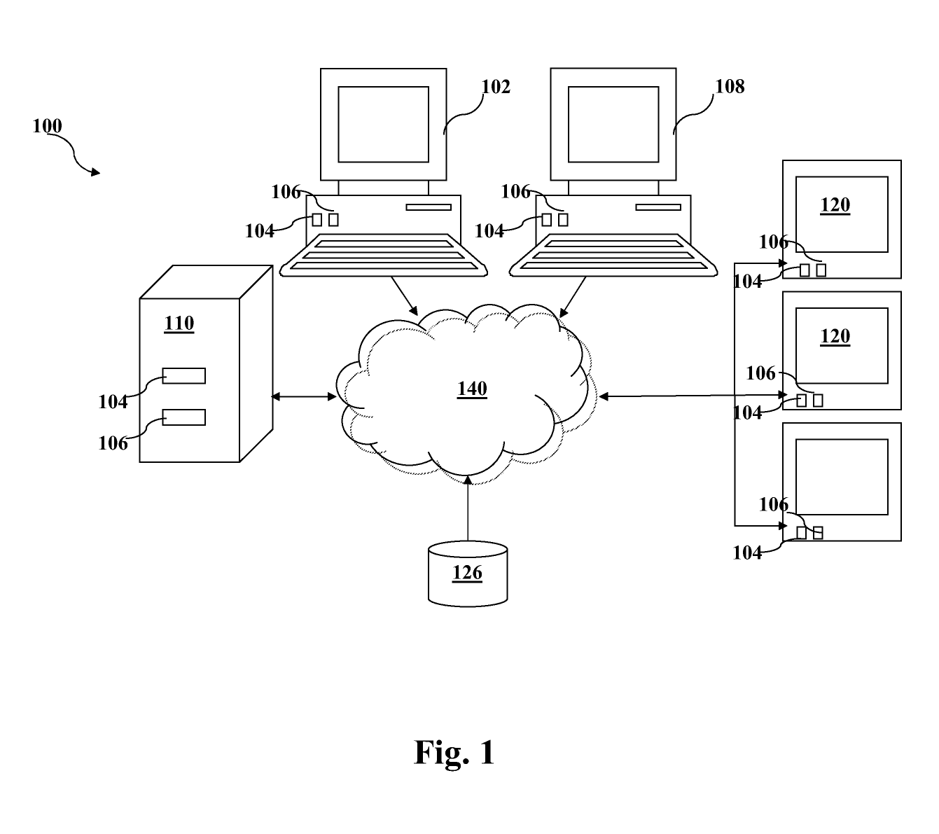

Reference is made to FIG. 1, which schematically illustrates an expertise performance management system 100 according to an embodiment of the invention. Devices in system 100 may connect and transmit data via a network 140, which may be any wired or wireless network, such as the Internet or World Wide Web, radio or telephone network.

Expertise performance management system 100 may include one or more computer(s) 102 each operated by a project manager connected to a plurality of computers 120 each operated by a respective responder.

A server 110 may provide project manager computer(s) 102 with an application to create a project, may queue submissions from responder computers 120, may record evaluations of those submissions from project manager computer(s) 102 in a knowledge management database 126, may rank responders based on past evaluations stored in knowledge management database 126, and may generate reports compiling those evaluations.

Knowledge management database 126 may store evaluations for responders and/or work and statistical derivations thereof and other information for performance reports. The information stored in knowledge management database 126 is described in further detail with reference to FIG. 13. Knowledge management database 126 may be integral to or separate from server 110.

In one embodiment, project manager computer 102 may generate a request to a plurality of responder computers 120 for information to be used in a project. In response, server 110 may receive a submission from each of a plurality of responder computers 120 and a request from project manager computer 102 to incorporate at least one of the responder submissions into the project. Upon receiving the request to incorporate the submission, server 110 may automatically check whether or not the submission has been evaluated by a human reviewer, e.g., one or more project manager computer(s) 102. If the submission has been evaluated by the human reviewer, server 110 may incorporate the submission (or allow the submission to be incorporated) into the project, and if the work has not been evaluated by the human reviewer, server 110 may deny the request and prohibit the submission from being incorporated into the project. If the work has not yet been evaluated by the human reviewer, server 110 may send a reminder or notification to one or more project manager computer(s) 102 informing that the submission may not be used or incorporated into the project unless and until the work has been evaluated.

Once the work has been evaluated, the project and/or responder evaluation reports may be sent, e.g., from server 110 or project manager computer 102, to a computer 108 operated by an executive. In one embodiment, each submission may include a work product as standard content and, once evaluated, may include evaluations as metadata. Similarly, executive reports may include a project as standard content and an evaluation report as metadata. Evaluation metadata may be stored together with or separately from the standard work product content and may be accessed by the executive.

Each project manager computer 102, responder computer 120 and server 110 may include a memory 104 to store data and a processor 106 to perform the operations described herein.

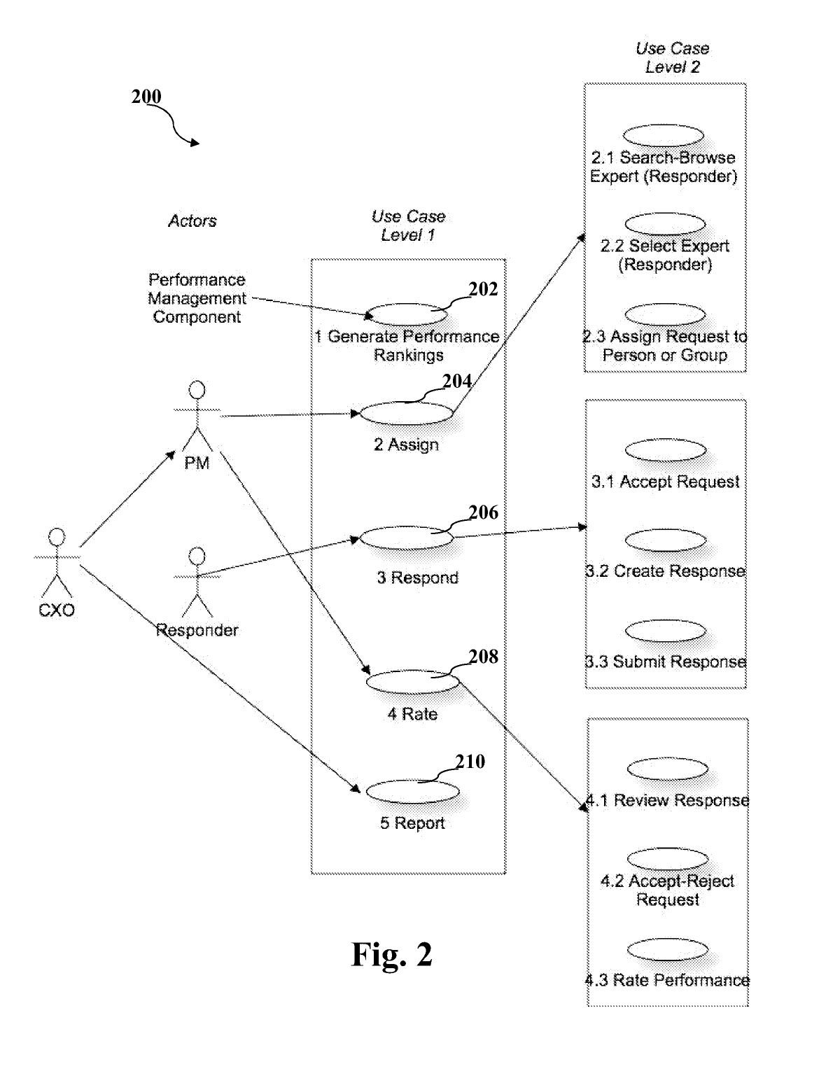

Reference is made to FIG. 2, which schematically illustrates an expertise performance management workflow 200 according to an embodiment of the invention. The method of FIG. 2 may be executed using the devices of FIG. 1. For example, an executive may operate computer 108 of FIG. 1, a project manager may operate computer 102 of FIG. 1, and a plurality of responders may each operate a computer 120 of FIG. 1 to implement workflow 200. The expertise performance management workflow 200 may include operations executed, e.g., by server 110 of FIG. 1, such as, generating performance rankings (202), receiving assignments of project tasks and assigning those tasks to individual or groups of responders (204), receiving work submissions from the assigned responders (206), receiving evaluations/ratings of those submission (208), and generating a report of responder evaluations (210). These operations are described in greater detail as follows.

Generating performance rankings 202: Using a database of historical performance ratings (e.g., stored in knowledge management database 126 of FIG. 1), the expertise performance management system (e.g., system 100 of FIG. 1) may generate a performance ranking or listing of personnel recommended for one or more specific project tasks. The recommended personnel may be compiled based on a substantially real-time calculation of past performance ratings for each available employee in the pool of candidate personnel. Rankings may be a numerical value, for example, from a highest performance value to a lowest performance value, or an order in a listing. Rankings may be computed based on employee ratings associated with each of a plurality of attributes that are pre-designated, e.g., by the project manager, as being relevant for the project.

A project manager (PM) may designate these attributes. Attributes may include, for example, the field of the project (customer service, data entry, etc.), the problem-type (product returns, inventory, etc.), the management level (e.g., the number of personnel managed for the task), etc. The ranking calculation for each employee may be an average of past ratings for that employee, e.g., in general or for each of the plurality of attributes pre-designated for the project. The average may be absolute or weighted, e.g. having an increased weight for more recent historical data or higher relevancy of project attributes, etc. Rankings may be calculated at the time that the project manager creates the project.

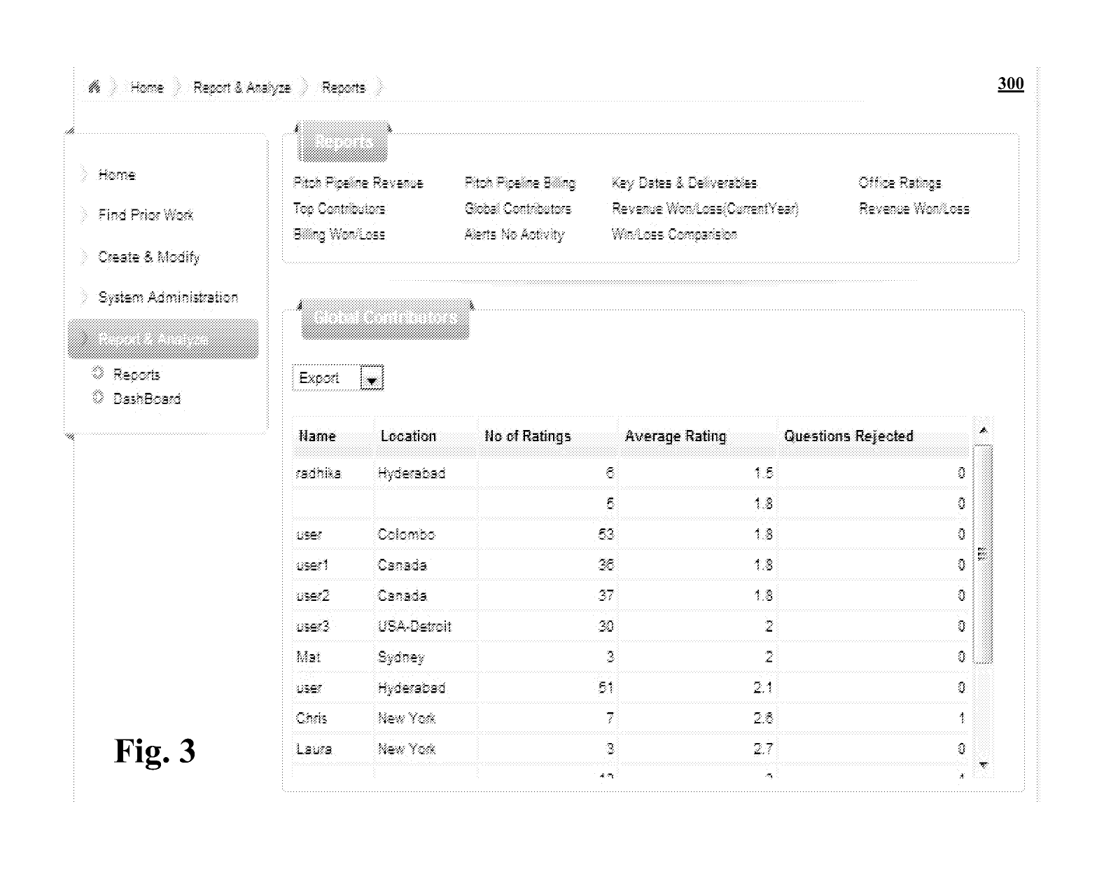

FIG. 3 shows an example of a user-interface 300 displaying employee performance rankings according to an embodiment of the invention. User-interface 300 may include identification of a plurality of employees by name and location and, for each employee, may report an associated number of ratings, average rating and number of questions rejected for the employee. These values are compiled from the knowledge database.

Receiving assignments of project requests/tasks 204 of FIG. 2: The project manager may assign a work request or task to an individual responder (or group of responders). In certain embodiments, once the rankings are listed, the project manager may assign a work request or task to an individual responder or group of responders, for example, to those employees who have been recommended, e.g., by the knowledge management database 126, as being most relevant for the specific project, based on the newly generated performance rankings.

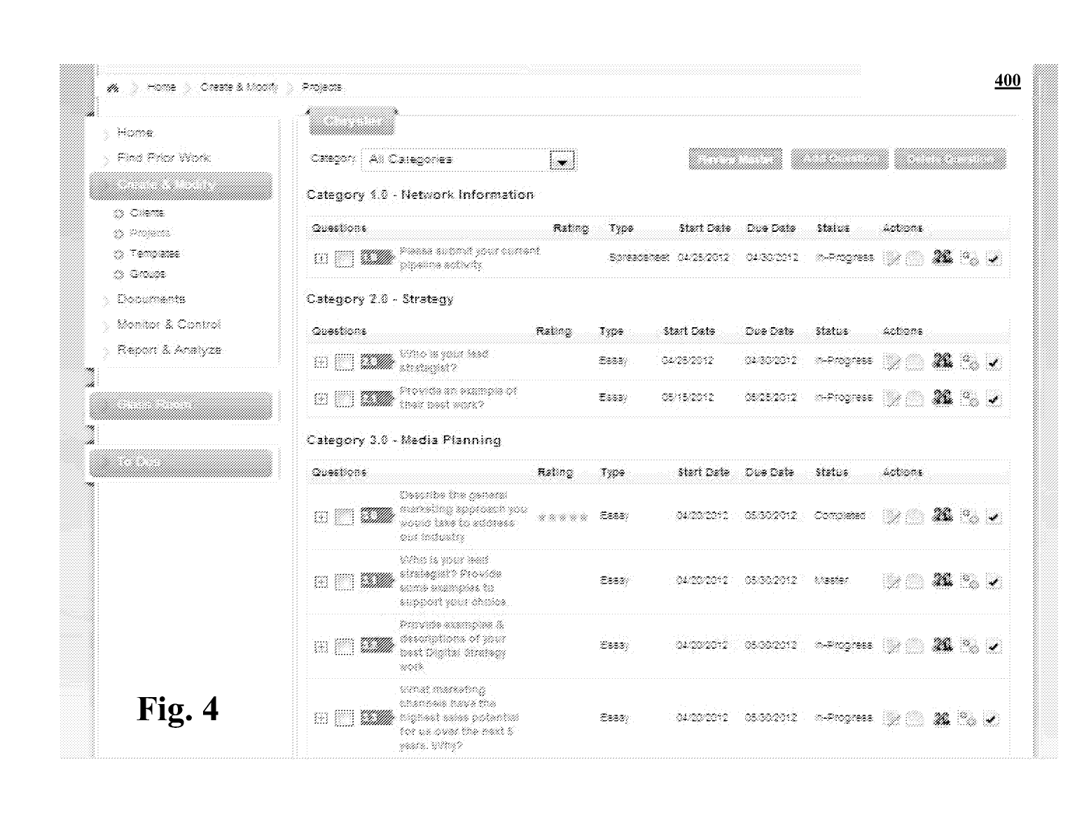

FIG. 4 shows an example project displayed on a user-interface 400 according to an embodiment of the invention. The example project includes a plurality of requests (e.g., “Please submit you current pipeline activity” and “Who is your lead strategist”). In this questionnaire format, some requests in the example project are questions requiring a spreadsheet type response or a free-hand type, or “essay” type, response. However, it should be noted that requests may also include any other format, such as, tasks, submission descriptions, data, etc.

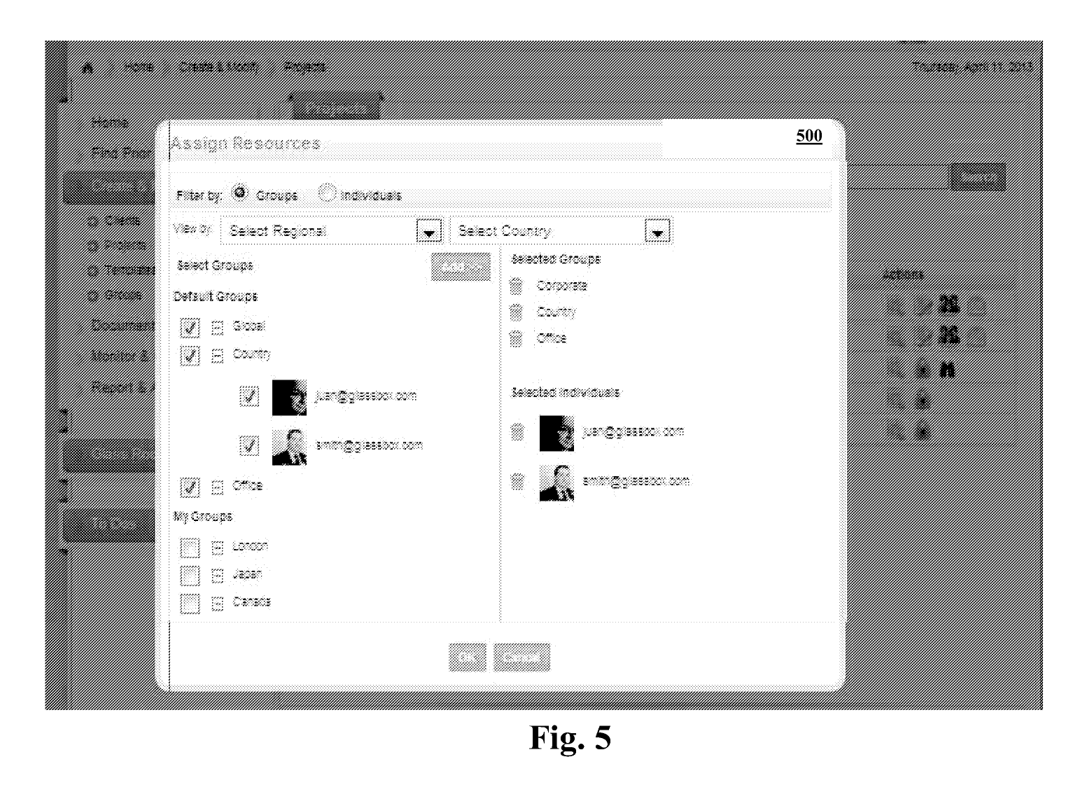

FIG. 5 shows an example of a user-interface 500 for assigning tasks or work requests to responders according to an embodiment of the invention. A project manager computer may operate user-interface 500, e.g., to select groups or individual responders to be assigned to questions or tasks. In the example of user-interface 500 shown in FIG. 5, groups of responders are selected, for example, by location (e.g., Regional, Country or Global) or using pre-designated groups (e.g., Office, Corporate or saved groups, such as, groups in London, Japan or Canada). The project manager may also switch from group assignment to individual assignment, e.g., by selecting the “individuals” filter field on user-interface 500.

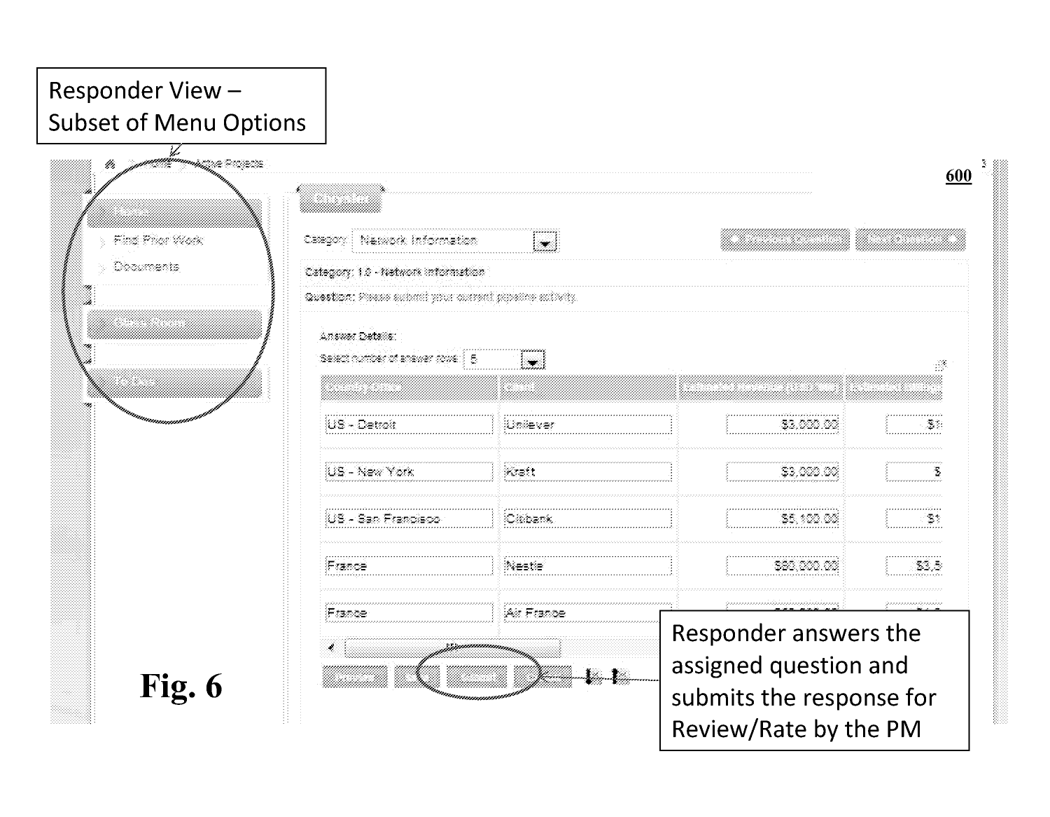

Receiving work submission from responders 206 of FIG. 2: The assigned responder may accept the work request, answer the assigned work request, and submit a response. The work request or document may be formatted according to a template designed by the project manager. FIG. 6 shows an example of a responder user-interface 600 according to an embodiment of the invention. Responder user-interface 600 shows a work template forwarded by the project manager, into which the responder enters content or answers questions to complete the assigned task. The responder submits this work to the project manager, e.g., via a submit field on responder user-interface 600.

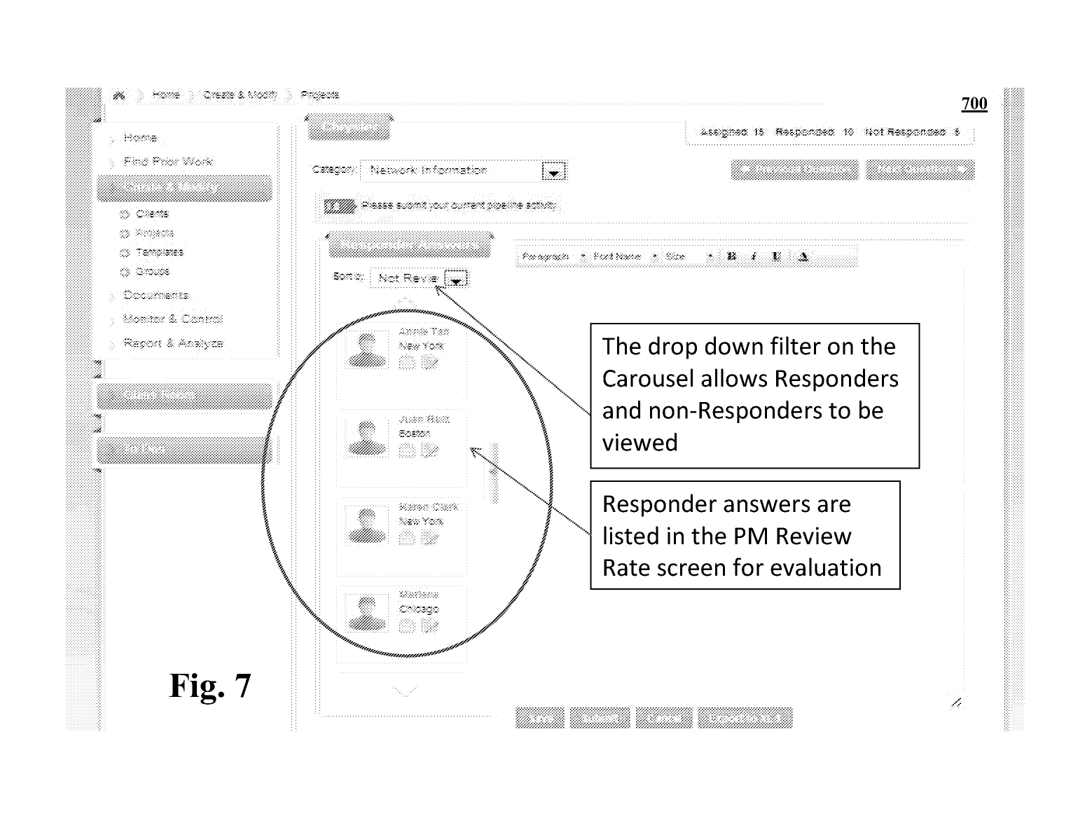

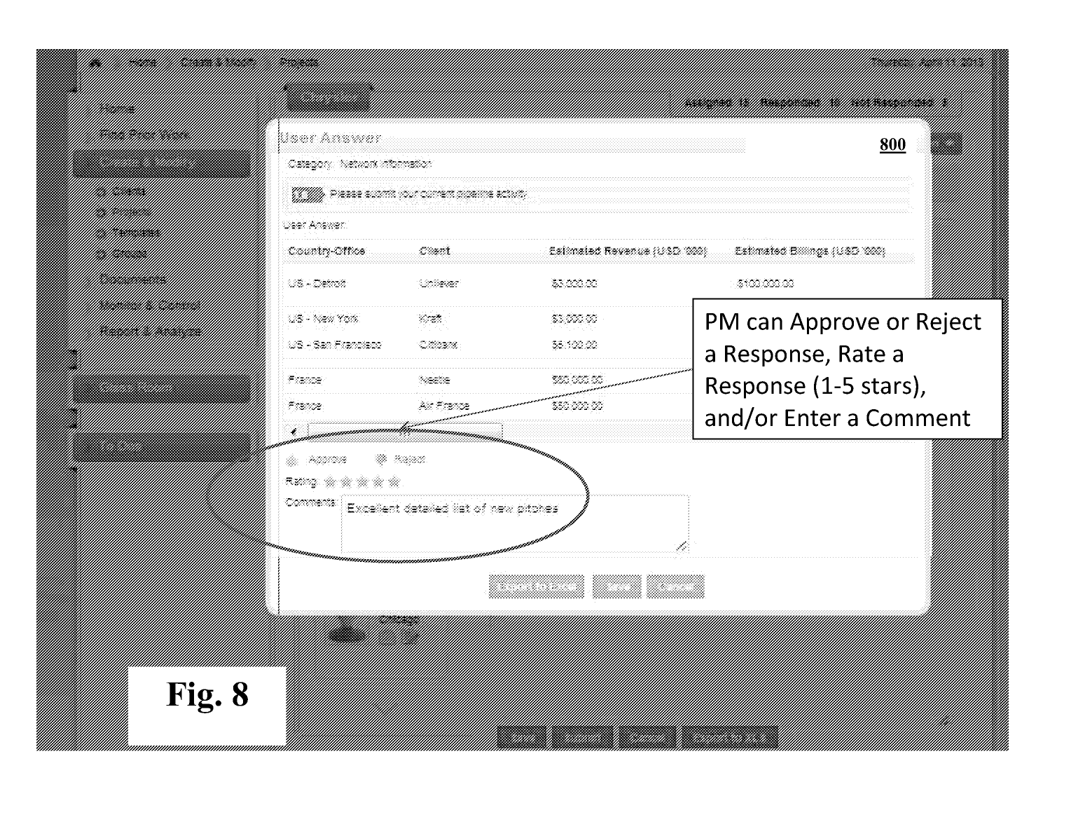

FIG. 7 shows an example of a project manager user-interface 700 for receiving and reviewing responder submissions according to an embodiment of the invention. In the example of user-interface 700 shown in FIG. 7, submissions received from responders are listed by the associated responder, which the project manager may select to view their work. User-interface 700 includes an optional filter to list a subset of responders based on any desired criteria, e.g., responders who have responded, not responded, submitted work that has been approved, submitted work that has been rejected, submitted work that has been excluded, submitted work that has been not reviewed, were personally best rated or submitted work that has been best rated, or filtered by name (user may be prompted to enter letters of a name or office and responder record(s) with the closest match are displayed), filtered by other factors, or not filtered to display all responders. Once a responder is selected, that responder's submission is displayed for review, e.g., in a project manager user-interface 800 shown in FIG. 8 (discussed below).

Receiving evaluations/ratings of submissions 208 of FIG. 2: The project manager may either accept or reject each responder's submission. Rejected responses may be routed back to the responder/employee with comments explaining how or why the response did not meet the request's criteria. Accepted responses may be rated by the project manager using one of the rating methods described above, e.g., a five-star method (wherein simply accepting may generate a default 3-star rating). The ratings may be stored in the knowledge database and may, for example, contribute to the employee's rank or relevance calculations for future projects.

FIG. 8 shows an example of a project manager user-interface 800 for simultaneously using and evaluating responder submissions according to an embodiment of the invention. User-interface 800 includes a display for the responder's work product (e.g., answers to a questionnaire or requests for information) and an adjacent display field for the project manager to utilize to evaluate that responder's work product. The evaluation display may include fields for the project manager to approve or reject the work, rate the work, enter comments discussing the work and/or incorporate the work into a project. The evaluation data entered in the evaluation display may be stored as metadata of the work product. Entry of data into the evaluation display may trigger a flag (e.g., in a “rating,” or “comment” field in table 1310 or 1312 shown in FIG. 13) or other indicator that the work has been evaluated. For example, the rating field in table 1310 indicates the actual rating provided and the rating field in table 1312 is the lookup table of rating values.

Reporting evaluations 210 of FIG. 2: The performance management system may generate real-time, periodic and/or scheduled reports. The reports may indicate the performance of business units, regions, the enterprise as a whole, as well as individuals and task-oriented teams. These scheduled reports and dynamic displays may provide executives, such as, a chief executive Officer (CXO), with ratings, comments and other information generated by the project manager to indicate employee performance and how well personnel are responding to specific problems and issues. This information may be used by executives to identify potential gaps in organizational knowledge and skillsets. These reports may also be used, e.g., by human resources (HR) to hire, fire, recruit and train personnel.

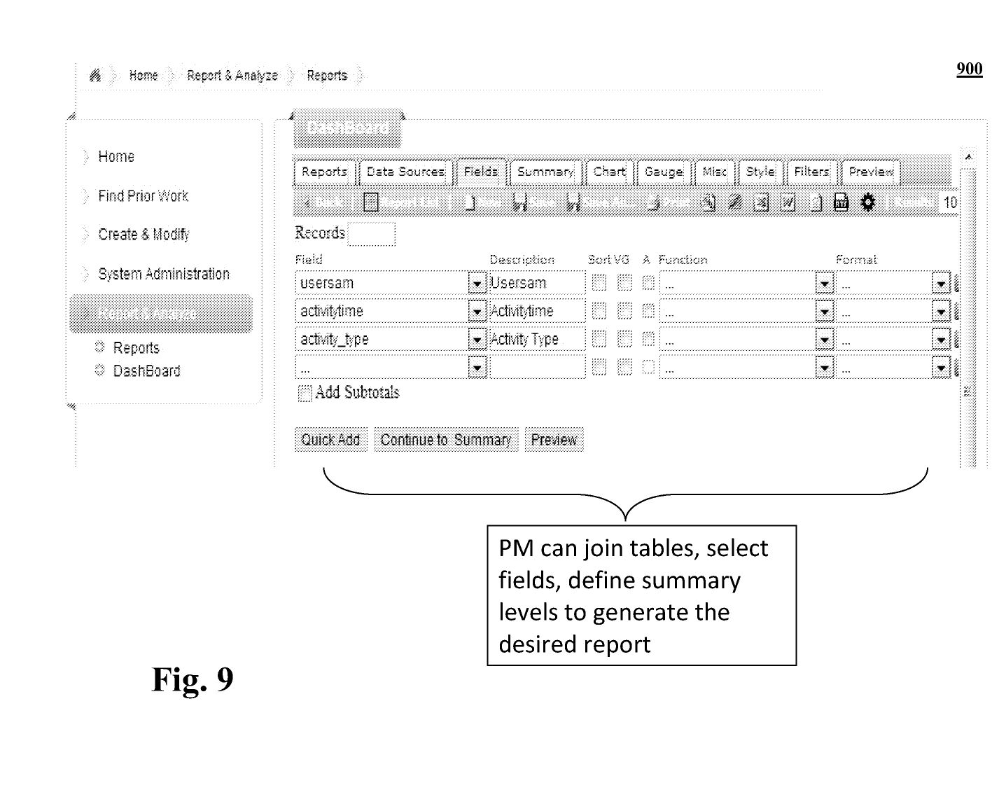

FIG. 9 shows an example of a project manager user-interface 900 for designing and generating a report according to an embodiment of the invention. User-interface 900 may provide the project manager with options to select one or more source(s) of data used for the report (e.g., for joining tables or questionnaires generated by multiple individual or groups of responders), one or more field(s) displayed in the report such as users/responders or activity time or type, summary of the data, charts to display the data, gauges allowing user to select parameters for the display of the report (e.g. sort, minimum values, maximum values, etc.) as well as a ‘gauge’ graphic style (dial or linear), a style for the report (e.g., an original design or a design selected from among pre-designed report style templates), filters to filter the report data, and an option to preview a report generated according to those parameters.

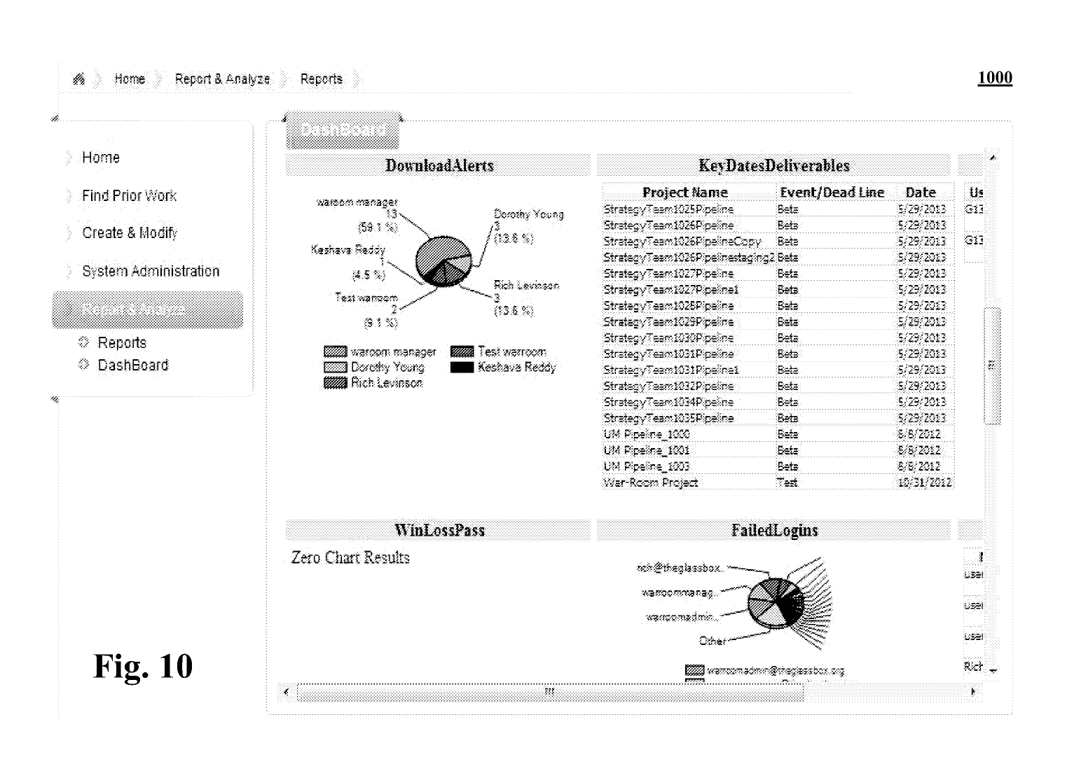

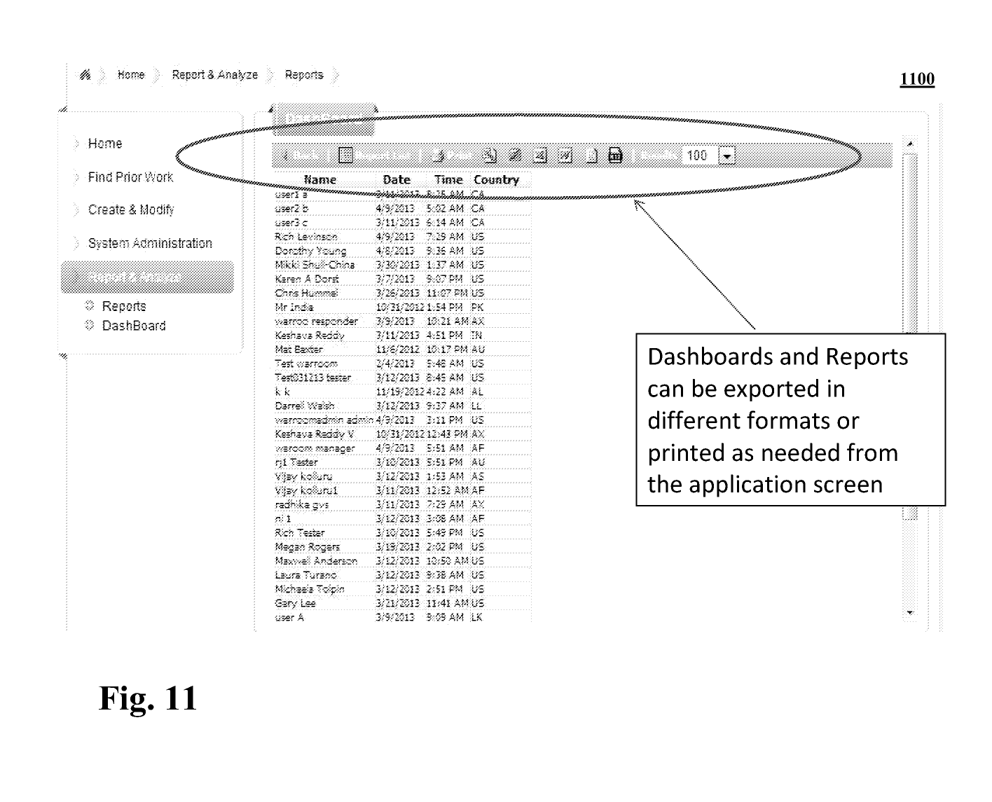

FIG. 10 shows an example of a user-interface 1000 displaying a report, e.g., to be viewed on an executive computer, according to an embodiment of the invention. In the example of user-interface 1000 shown in FIG. 10, the report is viewed on a “dashboard” and may include charts, project schedules, project names, event deadlines, etc. The viewer may select a project name or other field in the report to display data associated with the project, e.g., as shown in the user-interface 1100 of FIG. 11. FIG. 11 shows an example user-interface 1100 displaying a log-on history report of valid log-ins for a specified time period according to an embodiment of the invention. In user-interface 1100, the report data may be printed or exported to create report documents, e.g., in a selected one of a plurality of different formats.

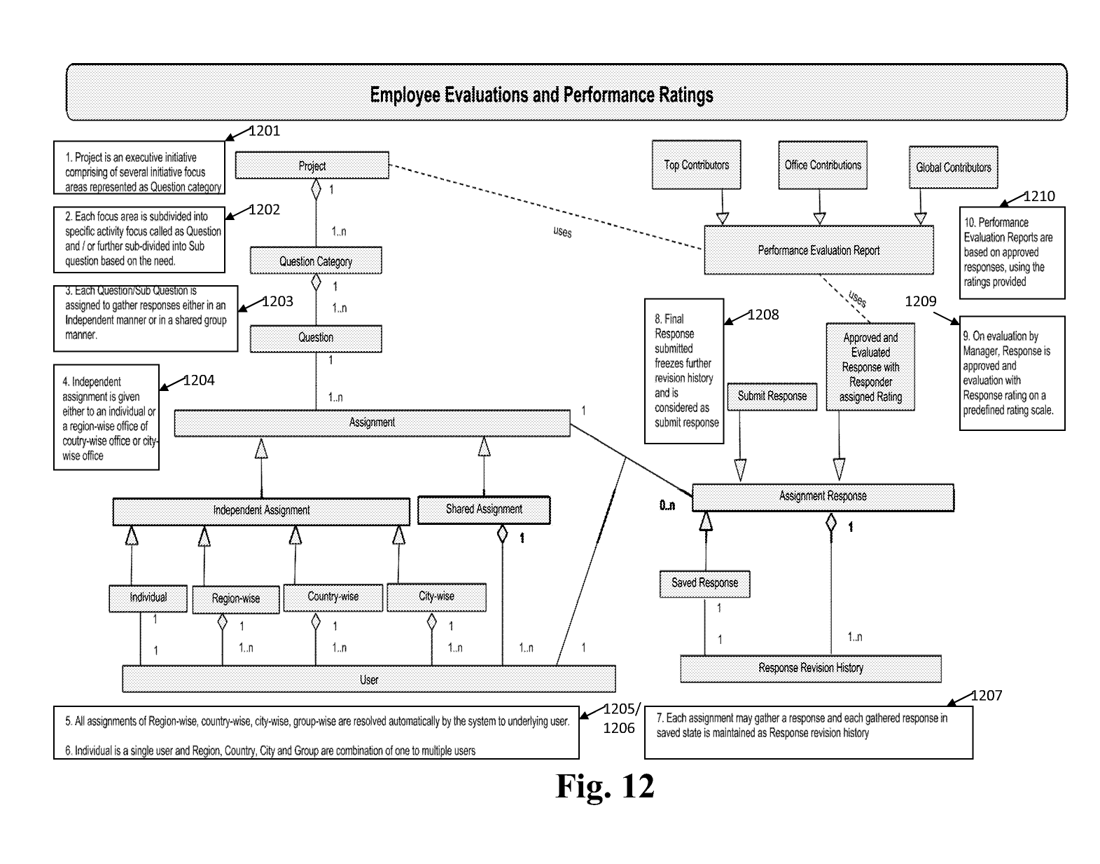

Reference is made to FIG. 12, which schematically illustrates a workflow 1200 for generating requests for information, for receiving responders' submissions in response to those requests, and for evaluating those responder/employee submissions, according to an embodiment of the invention. The method of FIG. 12 may be executed using the devices of FIG. 1.

In operation 1201, a project is created via a project manager computer. The project may be divided into categories of questions or tasks. In operation 1202, one or more question(s) or sub-question(s) is created in each project category. In operation 1203, each question or sub-question is assigned to an individual responder or in an independent or shared group manner. ‘Independent’ assignment means that each assigned responder provides his or her own unique response. ‘Shared’ assignment means that all users in a shared assignment, e.g. typically members of a group, provide a single response, e.g. for the entire group. If the question type is an essay, each person that connects to the answer screen may view the latest saved version of the answer from any member of the group. For example, if a user (1) in the group is in the process of answering a question and a user (2) attempts to access the answer screen, user (2) may be locked out from updating the answer until user (1) has saved and/or exited the answer screen, preventing contention and preserving the data integrity of the answer.

In operation 1204, independent assignment may be made by selecting individual personnel, or groups of personnel as an ‘independent’ assignment for each group member, or groups of personnel as a ‘shared’ assignment where members of a group collaborate on a single response, e.g., selected region-wise, country-wise or city-wise.

In operation 1205/1206, personnel that were independent assigned, for example, members of independently assigned groups, are associated with the questions. An individual is a single user and a group is one or multiple users linked to a group profile.

In operation 1207, submissions or responses to the questions are received from the assigned responders. Each response is saved, e.g., at a server and/or database. Once each response has been submitted, it may be further supplemented by the responder with additional information, and each received response is saved in a response revision history. In operation 1208, final responses are received to update the revision history.

In operation 1209, responses are evaluated, e.g., approved and rated, by a project manager. Once a response has been evaluated, it is unlocked for use by the project manger in the project, as discussed above. Until an evaluation on a response has been submitted, that response is “locked” and may not be used or utilized by the project manager in any fashion, other than as needed for evaluation, e.g., reading.

In operation 1210, a performance evaluation report may be generated based on approved responses, and may be used by the project manager in that project or by that or another project manager in subsequent projects. The responses may be compiled according to the evaluation ratings. For example, responses may be statistically weighted according to their rating, or responses may be filtered to compile into the report only responses with at least a minimum threshold rating. Only evaluated and/or approved responses may be used in operation 1210. Unevaluated and/or rejected responses may be locked or prohibited from being compiled into the report.

Reference is made to FIG. 13, which schematically illustrates data structures for state data for a project, responder evaluations, and reports according to an embodiment of the invention. The state data may have values, alpha-numeric entries or on/off flag values. The state data may be stored in a knowledge management database (e.g., database 126 of FIG. 1).

Table 1302 may store state data defining a project, for example, entered in operation 1201 of FIG. 12. The project states may include, for example, a project name, a project identification (ID), a client ID, a project type, keywords, a short description, a project team, a search consultant, estimate billings, win potential (a likelihood of winning a pitch (e.g., as a percentage, 10%, 30%, 80%, etc.), results, a start date, an end date, status, comments, tag cloud or word cloud (e.g., a visual representation for text data, typically used to depict keywords of an entity (e.g., project) and is useful for quickly perceiving the most prominent terms and for locating a term alphabetically to determine its relative prominence (e.g., by size, color or other visual markers), a lock status (e.g., a status of the project that is locked, where the project is completed and is closed to updates), job number, user ID, rolling project, owner observed assigned data and project configuration type.

Table 1304 may store state data defining a question category or area of focus, for example, defined in operation 1201 of FIG. 12. The category state data may include, for example, a category ID, a category name and a category status.

Table 1306 may store state data defining a question, for example, defined in operation 1202 of FIG. 12. The question state data may include, for example, a question ID, a question category, a question level, question text, a start date, an end date, qualifiers, a question status, a project ID, an indicator of whether attachments are allowed to respond to the question, a lock status, an answer count indicating the number of responses or accepted responses to the question, a template ID, users, master question, sub-questions, assigned date, whether answering the question is mandatory for all assigned users, passed users, delegate user, make private and private users.

Table 1308 may store state data defining users assigned to the question defined by table 1306. The assigned user data may be generated, for example, by the assignment of individual or groups of users in operation 1203 of FIG. 12. The assigned user state data may include, for example, ID, user first name, user last name, user description, organization, geography, country, state, city, user ID skills, job title, about me, address and user logo.

Table 1310 may store state data defining answers, submissions or responses to the question defined by table 1306. The answer data may be received, for example, according to operations 1207 and/or 1208 of FIG. 12. The answer state data may include, for example, an answer ID, a question ID, a name of the user that submitted the answer, a rating determined by a project manager evaluating the answer, a comment entered by a project manager evaluating the answer, a status as to whether or not the answer is evaluated, a template ID indicating the template in which the answer/question appear, an indicator of whether or not the answer includes an attachment, an answer submit date, a location of the user that submitted the answer, a category of the question, a field indicating whether or not the answer was submitted, a group flag indicating if the answer was submitted by a group, the ID of that group, the name of that group and the size of that group.

Table 1312 may store state data defining evaluations of the answers in table 1310. The evaluation data may be generated, for example, in operation 1209 of FIG. 12. The evaluation state data may include, for example, an answer ID, a rating, a rating value, a status indicating if the response is accepted or rejected.

Other or different data structures and data entries may also be used.

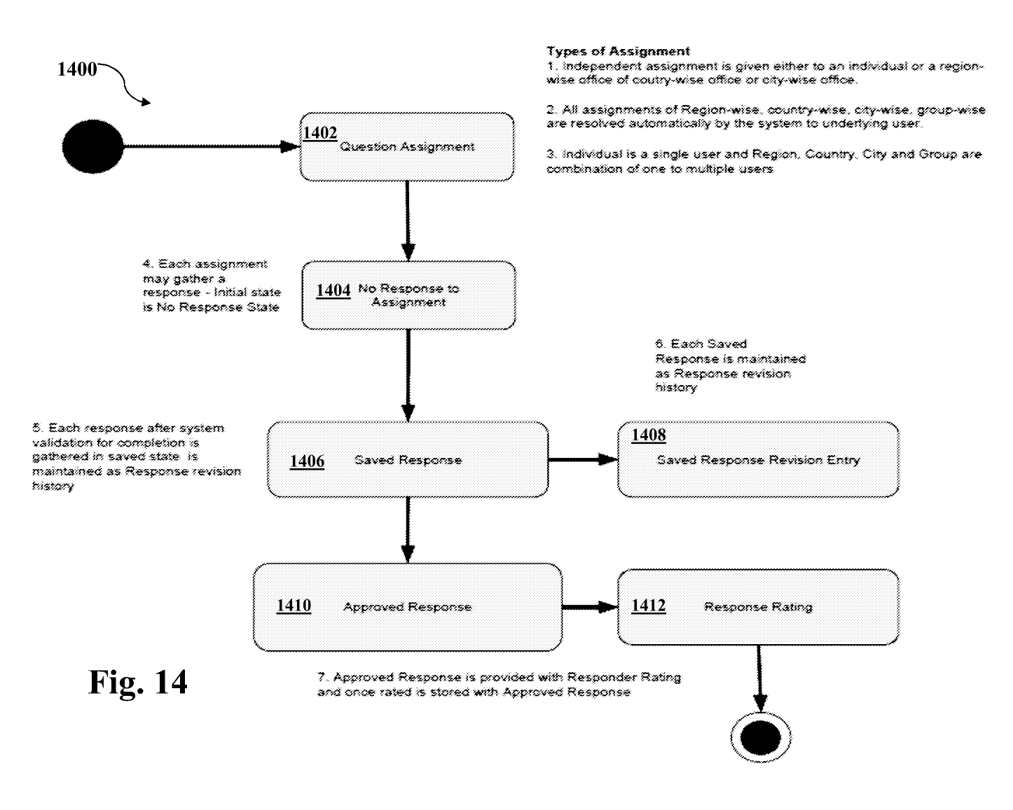

Reference is made to FIG. 14, which schematically illustrates a workflow 1400 showing the changes in state related to performance evaluation according to an embodiment of the invention. Workflow 1400 of FIG. 14 may be executed using the devices of FIG. 1.

In operation 1402, questions may be assigned to responders, e.g., by a project manager (via computer 102 of FIG. 1). Assignment may be designated as individual, in which each responder provides an independent response as an individual responder or a member of a group. Alternatively, the assignment may be designated as shared, in which all responders in an entity (e.g. a group) provide a single response. An independent assignment may gather a response for each responder. For example, an independent assignment to a group or (n) members may gather (n) responses.

In operation 1404, the project or questions may initially be in a “no response” state, for example, when questions have been assigned but no responses have been returned and/or approved.

In operation 1406, responses are received from responders (e.g., from computers 120 of FIG. 1) and saved (e.g. in memories 136 or 104 of computer 102 or server 110 of FIG. 1).

In operation 1408, each saved response is recorded in a response revision history.

In operation 1410, a subset of responses may be approved and a subset of responses may be rejected, e.g. by the project manager.

In operation 1412, the approved responses may be rated.

Once responses are approved and/or rated, the responses may be unlocked for use in a project.

According to one non-limiting example, a project may be generated as a questionnaire including several, e.g., ten, questions.

Questions may be assigned to several, e.g., eight, different responders. Questions may be assigned to individuals or groups of users. Users may be searched for or categorized in groups based on geographical region, e.g., city, state or country. Users may be assigned manually by the project manager, automatically as the best ranking responders, e.g., in total or for a specific category per question, or semi-automatically where the processor automatically selects a small pool of the available responders (e.g., the best ranking responders, responders that scored or qualified above a threshold rating in that relevant question category, or responders that are in time zones that are “available,” e.g., within office hours, when submissions are needed) and the project manager manually selects the final responders from among the users in that small pool. In some embodiments, “available responders” may include all personnel in a team, company, or other group, a sub-set of responders who are not assigned to other work, a sub-set of responders having a cumulative amount of assigned work that is less than a maximum work load for that responder, and/or a sub-set of responders who have been assigned work of lesser priority than that of the current project.

The responders may submit their answers or responses to the project manager's request for information. In one embodiment, when a responder submits an answer or response, the response is saved to a database (e.g., knowledge management database 126 of FIG. 1) and an answer or response flag is switched on (e.g., answer_ID flag in table 1310 of FIG. 13). The database may store information related to the answer or response in a table (e.g., table 1310) per project, category, or question in a hierarchical storage structure. The answer or response may be sent from the database to the project manager either automatically, in batches or when the project manager requests answers to the associated questions. When the responder submits an answer or response, the response is locked from being edited by the responder and/or from being reviewed, used or incorporated into a project by the project manager. In order to unlock the answer, the project manager must evaluate the answer.

The project manager may evaluate the answers or responses by approving or rejecting, rating and/or commenting on each answer or response. Evaluation data may be captured and transmitted from the project management computer to a centralized server (e.g., server 110 of FIG. 1) in real-time. The server may store the captured evaluation data in the database as raw data or as processed data (e.g., normalized so as to eliminate reviewer bias). The evaluation data may be metadata of the response data. The evaluation metadata and its associated response may be linked via a table (e.g., table 1312 of FIG. 13 defining the response by a response ID and defining the evaluation fields by ratings, rating values and status indicators). Once the responses have been evaluated and/or approved, the responses may be unlocked for editing, saving, or incorporating into a project.

In one embodiment, when the project manager selects a response to be used in final documents for the project, a processor or module checks (1) if an “evaluation” flag is set indicating that the work was evaluated and (2) if work is “accepted” (or not rejected) and/or (3) if the evaluation score/rating is higher than a threshold minimum value (e.g., greater than three-stars). Accordingly, a project cannot use responses until those responses have been evaluated and/or sufficiently scored. In this way, the project manager acts as a gate-keeper that evaluates all content that is part of a final report. Since evaluating a response is required in order for the response to be unlocked for use, embodiments of the invention enforce real-time evaluation, e.g., at the time of the project's creation or at the time of consideration of the responses submitted in reply to a request, so that the project cannot to proceed until sufficient quality control is established and the performance evaluations have been submitted.

Reports are generally created by the project manager for an executive. Reports may include the final project and/or the evaluation data associated with the work in that project or the responders that contributed that work. In one embodiment, a cumulative project score or evaluation may be compiled from the evaluations of the associated work or answers. The project score may be reported with the project. If project score is below a predetermined minimum threshold, the project may be locked and will not compile, or a warning may be issued to the project manager that the quality is unacceptable. The project manager may be locked from merely changing scores to artificially increasing the project score and may be required to incorporate new work and/or work from new responders.

The executive may also evaluate the work, which may override or add to the initial project manager evaluation data. The executive may also evaluate the project as a whole to evaluate the project manager.

All ratings and other evaluation data may be saved in the database as part of each responder's history, e.g., averaged per category, per project, etc. The responder history may be used in future projects to rank each responder based of their past evaluation data. The project manager may select future project responders based on such rankings.

It may be appreciated that evaluating work in “real-time,” simultaneously to, or during a period in which the work is being used may refer to evaluating and using the work in overlapping time intervals, during the same “session”, e.g., a time period starting when a user logs onto a project or account and ending when the user logs off the project or account or within a sufficiently small time gap, e.g., less than 1, 10, 30 or 60 minutes apart. Substantially at or during a time refers to a time gap or delay of, e.g., 10 seconds to one minute.

It may be appreciated that although certain devices and functionality are assigned to “responders,” “reviewers,” “project managers,” “executives,” “employees,” etc., such functionality may be implemented by any users in any environment.

Different embodiments are disclosed herein. Features of certain embodiments may be combined with features of other embodiments; thus certain embodiments may be combinations of features of multiple embodiments.

Embodiments of the invention may include an article such as a computer or processor readable non-transitory storage medium (memory 104 of FIG. 1), such as for example a memory, a disk drive, or a USB flash memory encoding, including or storing instructions, e.g., computer-executable instructions, which when executed by a processor or controller (e.g., such as processor 106 of FIG. 1), cause the processor or controller to carry out methods disclosed herein.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

1. A method for evaluating responders comprising:
receiving a submission from each of a plurality of responders in response to a request for information;
receiving a request to incorporate the submission from at least one of the responders into a project;
upon receiving the request to incorporate the submission, automatically checking whether or not the submission has been evaluated and rated by a human reviewer; and
if the submission has been evaluated by the human reviewer, incorporating the submission into the project, and if the work has not been evaluated by the human reviewer, denying the request and prohibiting the submission from being incorporated into the project.

2. The method of claim 1 comprising:
receiving assignments of one or more project tasks to the plurality of responders;
receiving evaluations of the submission from each of the plurality of responders; and
generating a historical record and a report of the evaluations.

3. The method of claim 1 comprising generating performance rankings for a plurality of responders ranking the responders based on their relative evaluation histories.

4. The method of claim 1, wherein the submission is evaluated substantially simultaneous to when the submission is incorporated into the project.

5. The method of claim 1 comprising incorporating into the project submissions only from responders whose submissions have been evaluated.

6. The method of claim 1, wherein evaluating the submission comprises accepting or rejecting of the submission, rating the submission or commenting on the submission.

7. The method of claim 1 comprising locking submissions that have not been evaluated by a human reviewer.

8. The method of claim 8, wherein locked submissions are read-only and cannot be edited.

9. The method of claim 8, wherein locked submissions cannot be selected to be incorporated into the project.

10. The method of claim 1, wherein the evaluation data is metadata of the submission content.

11. A system for evaluating responders comprising:
a processor configured to:
receive a submission from each of a plurality of responders in response to a request for information,
receive a request to incorporate the submission from at least one of the responders into a project; and
a memory to store the submission,
wherein upon receiving the request to incorporate the submission, the processor is configured to automatically check whether or not the submission has been evaluated and rated by a human reviewer, and if the submission has been evaluated by the human reviewer, incorporate the submission into the project, and if the work has not been evaluated by the human reviewer, deny the request and prohibiting the submission from being incorporated into the project.

12. A computer-readable storage medium comprising a set of instructions that when executed by a processor in a computing apparatus cause the processor to:
receive a submission from each of a plurality of responders in response to a request for information,
receive a request to incorporate the submission from at least one of the responders into a project; and
upon receiving the request to incorporate the submission, automatically check whether or not the submission has been evaluated and rated by a human reviewer, and if the submission has been evaluated by the human reviewer, incorporate the submission into the project, and if the work has not been evaluated by the human reviewer, deny the request and prohibit the submission from being incorporated into the project.
